(19) United States
(12) Patent Application Publication
(10) Pub. No.: US 2010/0257020 A1
(43) Pub. Date: Oct. 7, 2010

(54) USER-TARGETED REBATES

(75) Inventors: MASON D. BRYANT, SEATTLE, WA (US); JAMES D. RUSSELL, SEATTLE, WA (US); SIDDHARTHA CINGH ARORA, REDMOND, WA (US); ARUN K. SACHETI, SAMMAMISH, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/417,234

(22) Filed: Apr. 2, 2009

(51) Int. Cl. G06Q 30/00

(52) U.S. Cl. 705/10; 705/27; 705/14.19

(57) ABSTRACT

Methods, systems, and computer-readable media for presenting discount offers to a user. The discount offer may be based on a discount offered by a retailer or supplier and may be combined with a discount offered by one or more additional retailers or suppliers. The discount program may be coordinated by a centralized discount server that may track user browsing behavior and purchases. The discount server may present discounts based on a product previously purchased.

### BACKGROUND

Currently, manufactures and/or online retailers have several avenues to present rebates or discounts to online shoppers. For example, manufacture rebates or discounts may be communicated to online retailers and passed on to the user through the retailer's site. Online retailers may offer their own discounts through their web sites. Cash-back applications may provide cash back to users that purchase an item after clicking through a link to a participating retailer's web site. Advertisements that explain sales or discounted items may be presented to users based on keywords in the content of a website.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the invention generally relate to a method of presenting discount offers to a user. The discount offers may be presented to the user through an online retailer's web site. The discount, which may be in the form of a cash-back rebate, may be a combination of a rebate offered by the online retailer and a rebate offered by a supplier of products or services sold by the online retailer. In one embodiment, a centralized discount server sends a participating online retailer a discount offer optimized for a particular user visiting the online retailer's website. The centralized discount server may track the user's browsing history and purchases made through the discount program. This information may be leveraged by the discount server to combine the online retailer's agreed upon discount with a supplier discount that is likely to interest the user. In addition, the discount offers may be based on supplier-discount offers to purchase a second item that is complementary to a first item previously purchased by a user through a different online retailer.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is an exemplary distributed computing environment suitable for implementing embodiments of the invention;

FIG. 3 is a block diagram of an exemplary computing system architecture suitable for implementing embodiments of the invention;

FIG. 4 shows a user-activity table 400 containing entries related to users' browsing and purchasing history, in accordance with embodiments of the invention;

FIG. 5 shows a discount table 500 containing discount offers based on various criteria submitted by multiple online retailers, in accordance with embodiments of the invention;

FIG. 6 shows a discount table 400 containing discount offers having various criteria provided by a plurality of suppliers, in accordance with embodiments of the invention;

FIG. 7 illustrates communications occurring between a client device, a retailer's server, and a discount server when a user navigates to a retailer's web page and is presented a discount offer, in accordance with embodiments of the invention;

FIG. 8 shows a method of presenting a targeted-discount offer to a user viewing a web page associated with an online retailer, in accordance with embodiments of the invention;

FIG. 9 shows a method of selecting a targeted-discount offer for presentation to a user viewing a web page associated with an online retailer, in accordance with embodiments of the invention; and

FIG. 10 shows a method for presenting online discount offers to members of a discount program through retailer web pages associated with retailers that are participating in the discount program, in accordance with embodiments of the invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention are generally related to a system and method that combines supplier discounts with online retailer discounts to offer a single discount to a user visiting a participating online retailer's web site. The discount offer may be for goods or services of any kind. In one embodiment, a centralized discount server sends a discount offer to an online retailer for a particular user. The discount server may combine the discounts of the online retailer and a supplier of products and/or services offered by the online retailer based on browsing behavior and past purchases made by the particular user. The discount may be in the form of a cash-back rebate that is paid out by an entity running the discount program through the discount server. The discount server may have numerous supplier-discount offers and retailer-discount offers to select from when generating the targeted-discount offer.

As used throughout this disclosure, an online retailer's web site may contain several web pages. Thus, a web page is a single page and a web site is a collection of related web pages.

Accordingly, in one embodiment, one or more computer-readable media having computer-executable instructions embodied thereon for performing a method of presenting a targeted-discount offer to a user viewing a web page associated with an online retailer are provided. The method includes retrieving user information for a user of a computing device that has navigated to the web page associated with the online retailer. The online retailer is an entity offering products or services for sale through a web page and the user information includes a unique user identification that identifies the user. The method further includes determining that the user qualifies for a discount on one or more products or services offered by the online retailer through the web page. The method further includes communicating a request for a discount offer to display to the user, wherein the request includes the unique user identification, and a unique merchant identification that identifies the online retailer. The method also includes in response to the request, receiving the discount offer that includes a discount for one or more products or services offered for sale by the online retailer. The discount combines a retail discount agreed to by the online retailer and a supplier discount offered by a supplier of the one or more products or services. The method also includes displaying the discount offer to the user through the web page.

In another embodiment, one or more computer-readable media having computer-executable instructions embodied thereon for performing a method of presenting a targeted-discount offer to a user viewing a web page associated with an online retailer are provided. The method includes receiving a request from a computing device for a discount offer to display to the user that navigated to the web page. The discount request includes a unique user identification that identifies the user and a unique retailer identification that identifies the online retailer. The method also includes selecting the discount offer for one or more products or services offered by the online retailer. The discount offer includes a discount that is calculated based on a discount provided by the online retailer and a discount provided by a supplier of the one or more products and services. The method also includes communicating the discount offer to the computing device.

In yet another embodiment, a method for presenting online discount offers to members of a discount program through retailer web pages associated with retailers that are participating in the discount program is provided. The method includes receiving one or more supplier-discount offers for a plurality of products and services provided by one or more suppliers that are participating in the discount program. The method also includes receiving one or more retailer-discount offers from a plurality of online retailers that are participating in the discount program. The method further includes storing the one or more supplier-discount offers and the one or more retailer-discount offers in a discount-offer data store, comprising one or more computer-storage media. The method further includes receiving a request for a discount offer. The request includes a unique identifier describing the user and a unique identifier describing the one of the plurality of online retailers. The method also includes generating a targeted-discount offer that offers a discount to the user for one or more products or services offered for sale by the one of the plurality of online retailers. The percentage discount is a combination of percentage discounts offered in one of the one or more supplier-discount offers and one of the one or more retailer-discount offers. The method also includes communicating the targeted-discount offer to the requesting computing device. The targeted-discount offer is displayed to the user through a web page of the one of the plurality of retailers.

Having briefly described an overview of embodiments of the invention, an exemplary operating environment suitable for use in implementing embodiments of the invention is described below.

### Exemplary Operating Environment

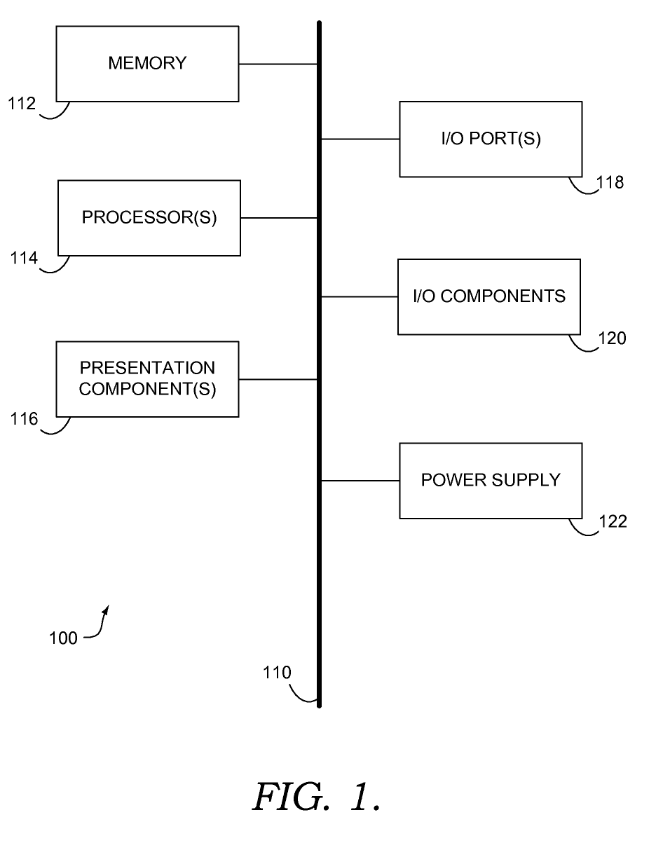

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120t. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-storage media. By way of example, and not limitation, computer-readable media may comprise Random Access Memory (RAM); Read Only Memory (ROM); Electronically Erasable Programmable Read Only Memory (EEPROM); flash memory or other memory technologies; Compact Disk Read-Only Memory (CDROM), digital versatile disks (DVDs) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

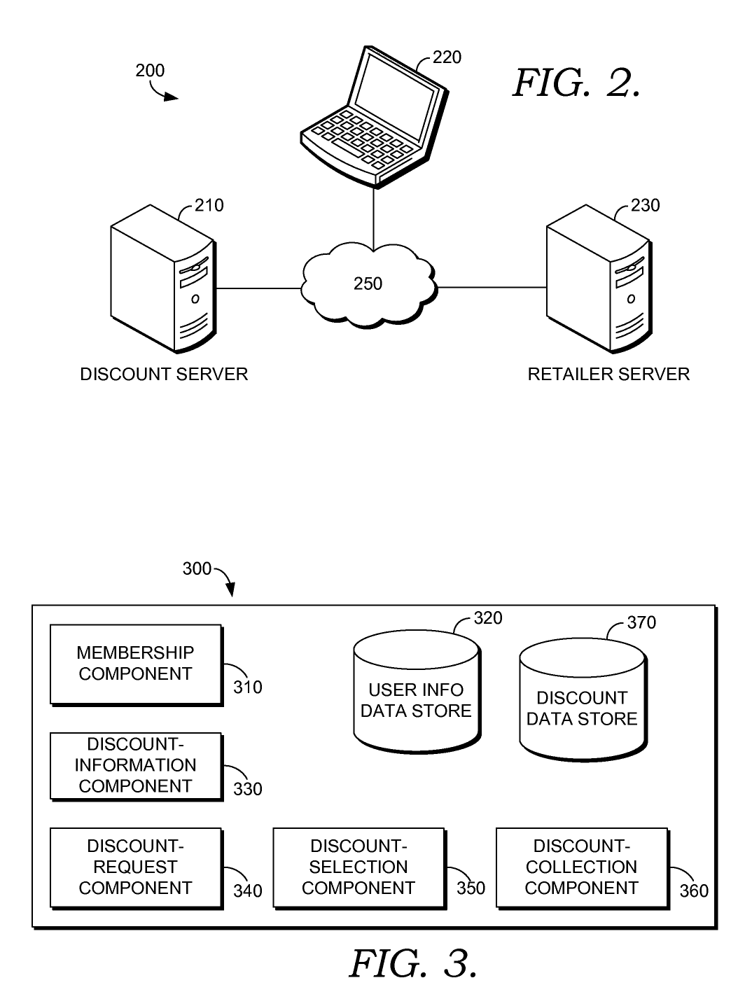

FIG. 2 shows an illustrative operating environment in a distributed computing environment. FIG. 2 includes a discount server 210 coupled to a client device 220 and a retail server 230 through network 250. The client device 220 and servers 210 and 230 may be interconnected through network interfaces, included on the devices, which are communicatively coupled to the network 250. The network may be a LAN, or a WAN, including the Internet. Such networking environments are commonplace in offices, enterprise-wide computer networks, intranets, and the Internet.

Client device 220 may be similar to the computing device 100 explained with reference to FIG. 1. Examples of suitable client devices 220 include PC's, lap tops, smart phones, PDA's, and the like. A browser on the client device 220 may be used to access web sites associated with the discount sever 210 and the retail server 230. The discount server 210 manages a discount program in which retailers, suppliers, and users may participate. The functions of the discount server 210 will be explained in more detail subsequently. In brief, the discount sever 210, may receive discount offers from online retailers and suppliers, collect user browsing and purchasing information, keep track of rebates due users, and provide discount offers for online retailers to display to users. The retail server 230 hosts a web site through which products and services are offered for sale to users. The online retailer associated with the retail server 230 participates in the discount program managed by the discount server 210. The retail server 230 may request discount offers from the discount server 210, and in turn, receive discount offers to be displayed to a user.

### Exemplary System Architecture

Turning now to FIG. 3, a block diagram is illustrated that shows an exemplary computing system architecture 300 suitable for presenting online discount offers to a user through an online retailer's web site. It will be understood and appreciated by those of ordinary skill in the art that the computing system architecture 300 shown in FIG. 3 is merely an example of one suitable computing system and is not intended to suggest any limitation as to the scope of the use or functionality of embodiments of the invention. Neither should the computing system architecture 300 be interpreted as having any dependency or requirement related to any single component/module or combination of components/modules illustrated therein.

Computing system architecture 300 includes a membership component 310, a user-information data store 320, a discount-information component 330, a discount-request component 340, a discount-selection component 350, a discount-collection component 360, and a discount data store 370. Computing system architecture 300 may reside on a single computing device, such as computing device 100 shown in FIG. 1. Alternatively, computing system architecture 300 may reside in a distributed computing environment that includes multiple computing devices (e.g., servers, clients) coupled with one another via one or more networks. Such networks may include, without limitation, one or more local area networks (LANs) and/or one or more wide area networks (WANs). Such network environments are commonplace in offices, enterprise-wide computer networks, intranets, and the Internet. Accordingly, the network, or combination of networks, is not further described herein.

The membership component 310 provides an interface through which users can enter information and view information related to a discount program. In one embodiment, the interface is presented to the user through a web page hosted by a discount server. Using the web page provided by the membership component 310, users can join the discount program by entering information about the user. In one embodiment, user information required to join the discount program includes an e-mail address, mailing address, name, a username, and a password. The username and password may be used in the future to grant a user access to discount program information such as rebate statuses. In embodiments where rebates are sent to the user, bank or credit card information may also be requested.

In addition to allowing the user to join or cancel the discount program, the interface provided by the membership component 310 may allow the user to check rebate information. Rebate information may include the total amount of rebates earned and individual transactions that contributed to the user's rebate amount. The amount of their rebate earned that is currently redeemable may be shown where there is a time delay before the rebate becomes payable. A time delay may be desirable to avoid fraud or mistakes that would result from the user returning the product for which the rebate was earned.

Another possible function of the web page generated by the membership component 310 is to provide a portal for users to find retailers and suppliers that are participating in the discount program. For example, the portal may include a list of participating retailers. A search interface may be provided that allows the user to quickly locate a desired retailer, or check whether a particular retailer is participating. A list of products or services for which discounts are provided by suppliers may also be listed on the portal web page. In addition to products where specific discounts are available, general products offered by one or more participating retailers may be listed. The listing may include pricing combined with discounts or rebates available from the individual participating online retailers. In one embodiment, in order to qualify for a rebate, the user must click through one of the links on the portal web page provided by the membership component 310 to be qualified for the discount.

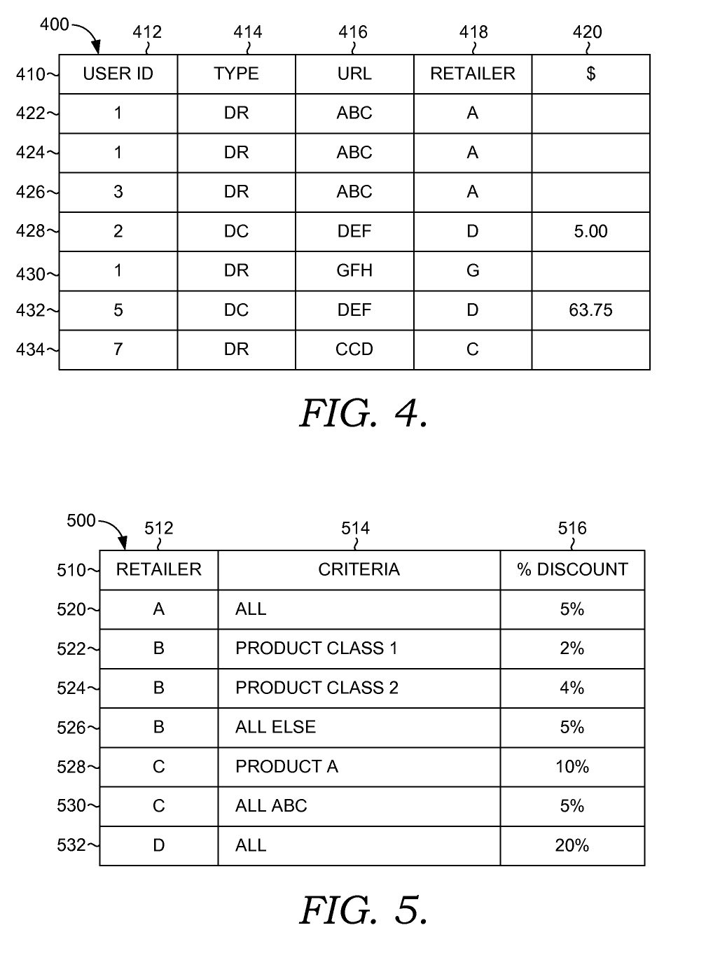

Information gathered by the membership component 310 may be stored in the user info data store 320. Membership information may be stored in a table or other format within the user info data store 320. The user info data store 320 also stores information related to a user's purchases, browsing history, and other online or offline activities. As shown in the user ID column 412 of FIG. 4, each of these entries may be associated with a user through the use of unique user identification. FIG. 4, which shows a user-activity table 400 containing entries related to users' browsing and purchasing history, will be explained in more detail after the components that generate the entries included in the user-activity table are explained.

Returning now to FIG. 3, computing system architecture 300 also includes a discount-information component 330. The discount-information component 330 receives discount offers for retailers and suppliers of products and services. The discount-information component 330 may provide an interface through which suppliers and online retailers may submit discount offers that may be combined and passed along to the user. The discount-information component 330 stores the discount offers in discount-data store 370. Retailers, supplier, manufactures and others may provide a variety of different offers that may be passed along to users. For example, retailers could provide a discount on all products offered through their web page. In another embodiment, online retailers may offer a first discount for a certain product or service, or a certain discount for a particular class of product or service. Products and services include almost anything that could be sold. Products include consumer goods, groceries, electronics, movies, MP3 downloads, software downloads, books, toys, animals, and other such items. Services may include travel services such as airline tickets, car rentals, hotels, cruises, vacation packages, accounting services, tax services, home-cleaning services, auto-repair services, medical services, home refinancing, banking services, investing services, and other similar services. This list of services and products is not meant to be exhaustive and almost any product or service that is exchanged for monetary value may be discounted by retailers and suppliers through embodiments of the present invention.

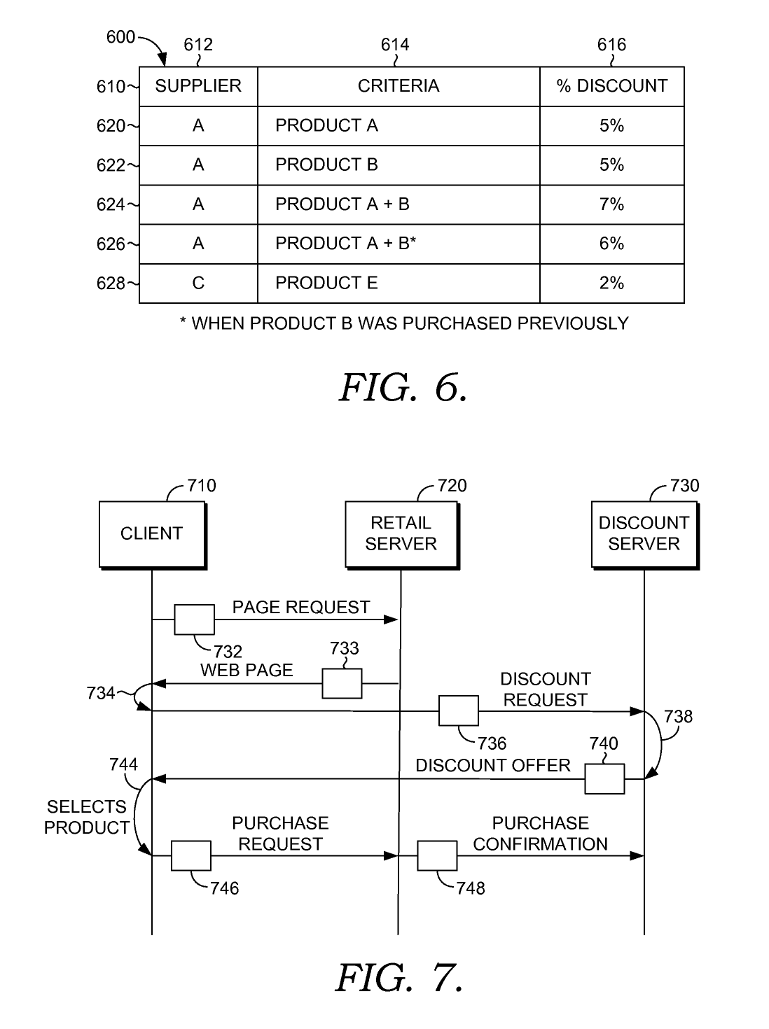

Suppliers of goods and services may also submit discount offers through the discount-information component 330. Suppliers may offer blanket discounts for goods or services they provide. In addition, they may provide individualized discounts for certain goods or services they provide. In other words, an individual supplier may provide a 5% discount for a first good or service and a 10% discount for a second good or service. In addition, the suppliers may provide combination offers. For example, a supplier could offer a 5% discount on a first item and a 5% discount offer on a second item, or a 10% offer when both items are purchased by the same user. In one embodiment, the combination discount offer may be presented when one of the two products or services that are part of the combination offer have been purchased previously as recorded in the user info data store 320. The item may have been purchased from a first retailer and a discount could be offered through a second retailer that is participating in the discount program. FIGS. 5 and 6 show examples of discount information that may be stored in discount data store 370.

FIG. 5 shows a discount table 500 containing discount offers that apply criteria submitted by multiple online retailers. Embodiments of the present invention are not limited to the fields shown in table 500. Additional information could be included with the discount offer including an expiration date, volume limit, and other limitations. In general, the discount offers will include information describing the online retailer that submitted the discount offer, the amount of the discount, and the products or services to which the discount applies. Row 510 shows the column headings for table 500. Discount offers 520, 522, 524, 526, 528, 530, and 532 are shown in the remaining rows. The first column identifies the retailer 512 associated with the discount offer. The second column shows a criteria 514 for the discount. The third column shows the percent discount 516 offered by the retailer. The discount offer 520 is submitted by retailer “A.” The discount criteria associated with the discount offer 520 is all, which means it applies to all goods and services offered by the retailer. In this case, the discount percentage offered as part of the discount offer 520 is 5%. The discount offer 522 is associated with retailer “B.” The criteria for the discount offer 522 is “product class 1.” Products in “product class 1” will be offered a 2% discount. The discount offer 524 is also associated with retailer “B.” The criteria for the discount offer 524 is “product class 2.” All items in “product class 2” will be given a 4% discount by the retailer. The discount offer 526 is again associated with retailer “B.” The discount criteria associated with the discount offer 526 is “all else.” The “all else” criteria applies to all goods or services not covered by “product class 1” or “product class 2” that were subject to the discount offers 522 and 524. In this case, goods or services falling into the “all else” criteria would receive a 5% discount.

Continuing with FIG. 5, the discount offer 528 is associated with retailer “C.” The discount criteria for the discount offer 528 is “product A.” Thus, under discount offer 528 product A qualifies for a 10% discount. The discount offer 530 is also for retailer “C.” The discount criteria associated with the discount offer 530 is “ALL ABC.” In this case, every good and service other than “product A” offered by retailer C is given a 5% discount. The discount offer 532 is associated with retailer “D.” The discount criteria for the discount offer 532 is “all.” In this case, all goods or services offered by retailer D will be given a 20% discount.

FIG. 6 shows a discount table 600 containing discount offers having various criteria provided by a plurality of suppliers. The fields shown in table 600 are merely exemplary. Embodiments of the invention are not limited to supplier-discount offers containing these fields. Several other additional fields may be included with the discount offer, but are not shown for the sake of simplicity. Row 610 shows the column headings in table 600. The first column identifies a supplier 612. The second column identifies a discount criteria 614. And the third column shows the discount percentage 616. The discount offer 620 is submitted by supplier “A.” The discount criteria for the discount offer 620 is “product A.” Thus, the discount offer 620 provides a 5% discount for product A. The discount offer 622 is also submitted by supplier “A.” The discount offer 622 has a discount criteria of “product B.” The discount percentage offered for “product B” is 5%. The discount offer 624 is also submitted by supplier A. The discount criteria for the discount offer 624 is “product A plus B.” This discount criteria offers a discount when both products A and B are purchased together. The discount percentage for the discount offer 624 is 7%. The discount offer 626 is also associated with supplier “A.” The discount criteria for the discount offer 626 is “product A plus product B*.” The asterisk indicates that the offer is good when product B was purchased previously. The discount percentage associated with the discount offer 626 is 6%. Thus, the discount offer 626 could be offered when the user has previously purchased item B and a supplier wants to encourage the user to purchase a complimentary item, product A. The discount offer 628 is submitted by supplier “C.” The discount criteria associated with the discount offer 628 is “product class E.” The discount percentage associated with the discount offer 628 is 2%. The discount criteria “product class E” extends the discount to all products and services provided by supplier “C” that fall within product class E. Embodiments of the present invention are not limited to the criteria shown in table 600. Embodiments of the present invention are not limited to the examples of discount information provided in FIGS. 5 and 6. Discounts could be based on the user's location or time of day. For example, a happy hour special could be offered to users in Chicago between 3 and 5 PM. Almost a limitless variety of discounts from retailers and suppliers may be received, combined, and presented to the user.

Returning now to FIG. 3, the discount-request component 340 receives requests for discount offers. In one embodiment, the discount offers are received from online retailers that have agreed to participate in the discount program. The discount requests may be generated by an online retailer when a user that is participating in the discount program navigates to their web site. In one embodiment of the invention, the user must navigate to the online retailer's web site by clicking through a portal provided by the membership component 310. This portal has been described previously. In another embodiment, the discount offer is generated by a widget that is downloaded as part of the retailer's web site and executed by the user's browser. In this embodiment, the request comes from the user's browser. A different widget may be associated with each web page. Each widget may contain product information for products offered for sale on the web page and information identifying the retailer.

The discount requests may include a unique identifier for the user, a unique identifier for the online retailer submitting the request, a URL associated with a specific web page that the user has navigated to, product information, as well as additional information. In one embodiment, the online retailer or widget retrieves the user identification information from a cookie that is loaded onto the user's computing device when they subscribed to the discount program through the membership component 310.

The discount-request component 340 forwards the discount request to the discount-selection component 350, which evaluates the various discount offers and selects one to be submitted to the web server hosting the requesting online retailer's web site. The discount-request component 340 may also store the discount requests in association with the individual users in user info data store 320.

The discount-selection component 350 provides a discount offer in response to a request for a discount offer from an online retailer. In order to select an appropriate discount offer, the discount-selection component evaluates the discount offer(s) submitted by the online retailer that submitted the request and supplier discounts for products and services offered by the online retailer. The discount-selection component 350 may consider discounts for products and services on the specific web page associated with the URL in the online discount request. The discount-selection component 350 may combine discounts from the online retailer and discount offers from a supplier to generate a single discount offer that is transmitted to the online retailer and displayed to the online user. The discount offer may be for a particular product, a class of products, a combination of products, and/or a complimentary product to a product previously purchased by the user. In one embodiment, the product previously purchased was purchased through a second online retailer. The discount offer may be in the form of a graphical image that is submitted to the online retailer. In another embodiment, the discount offer is in the form of a data file that is then translated into a discount percentage that is displayed through the user interface provided by the online retailer. For example, the discount offer could be incorporated into a line item on a checkout summary in a shopping cart. The online retailer could adjust the total price based on the discount provided.

In an embodiment of the present invention, when a user purchases an item through a participating online retailer, the online retailer sends a discount confirmation to the discount-collection component 360. The discount-collection component 360 receives discount confirmation and stores it in association with the user within the user info data store 320. This information may be used to generate a rebate for the user. The user may be required to wait a certain time period before the rebate may be redeemed.

FIG. 4 shows a user-activity table 400 containing entries related to users' event history. The events include discount requests for the user collected by the discount-collection component 340 and purchases made by the user that are collected by the discount-collection component 360. The event history may be used by the discount-selection component 350 to select a targeted-discount offer for the user. The user-activity table 400 includes a column listing the user ID 412, the type of information stored 414, a URL related to the type of information stored 416, a retailer associated with the type of information stored 418, and a dollar amount 420 of any discount that may be owed to the user. Row 410 shows headings associated with each column. Event 422 is a discount request message. Discount request messages are sent to the discount-request component 340 to request a discount to be displayed to a particular user. Each discount request is user specific and includes a unique user identification number that can be correlated with the user identification number stored in the user info data store 320. In addition to identifying the user, the discount request 422 also identifies the URL “ABC” and the retailer “A” associated with the discount request 422.

The discount request 424 for user 1 is associated with retailer “A” and URL “ABC.” The discount request 426 for user 3 is associated with URL “ABC” and online retailer “A.” The discount confirmation 428 for user 2 is associated with retailer “D” and URL “DEF.” The discount confirmation 428 includes rebate due in the amount of $5. The discount request 430 is for user 1 and associated with retailer “G,” which is associated with URL “GFH.” The discount confirmation 432 is for user 5. The discount confirmation 432 is associated with retailer “D,” which is associated with URL “DEF.” The discount confirmation 432 is in the amount of $63.75. The discount request 434 is associated with retailer “C,” which is associated with URL “CCD.” The discount request 434 is associated with user 7. Embodiments of the present invention are not limited to the information shown with reference to FIG. 4. Additional information describing the discount requests and discount confirmations may be included in the table. For example, the date of the discount request or the date of the discount confirmation may be included. Other examples of information that may be stored include product descriptions, web page descriptions, keywords associated with web pages and products, and other items.

FIG. 7 illustrates communications occurring between a client device 710, a retail server 720 and a discount server 730 when a user navigates to a retailer's web page and is presented a discount offer. The client device may be similar to client device 220 described previously with reference to FIG. 2. The retailer hosts an online retail web page and may be similar to retail server 230 described previously with reference to FIG. 2. The discount server manages a discount program and may be similar to discount sever 210 described previously with reference to FIG. 2.

Initially, a user on the client device 710 navigates to a web page associated with the retail server 720. Upon navigating to the URL associated with the retail server 720 the retail server 720 is sent a page request 732 from the client device 710. The page request 732 may be in the form of an HTTP GET request. While a single page request is shown in FIG. 7, in reality multiple requests and responses may be transmitted between the client device 710 and the retail server 720 while the page is downloaded. For example, each picture on a web page may require a separate request and response.

Upon receiving the page request 732, the retail server 720 communicates the web page 733 to the client device 710. The browser associated with the 710 the client device may then display the page and execute various code (e.g., Java widgets) associated with the webpage. In one embodiment, a widget is executed 734 that determines the client device 710 is a participant in a discount program that the online retailer associated with the retail server 720 is also participating in. The determination 734 may be made by evaluating a cookie on the client device 710 that is affiliated with the discount program. In one embodiment, a cookie is uploaded to the client device 710 when the user associated with the client device 710 joins the discount program. Upon determining 734 that the client device 710 is a member of the discount program, the widget may cause a discount request 736 to be sent to the discount server 730. The discount request 736 includes information describing the user associated with the client device 710. In one embodiment, this information is in the form of an unique user identification. The discount request 736 will also include a unique identifier to identify the retailer associated with the retail server 720. A URL for the specific web page to which the client device 710 navigated may also be included in the discount request 736. In one embodiment, the discount request 736 includes product information for one or more products offered by the online retailer. The product information may be stored in the widget associated with the web page. Each web page hosted by the retailer server 720 may be associated with a different widget that describes products on the page with which it is associated.

Upon receiving the discount request 736, the discount server 730 selects 738 a discount offer to send to the client device 710. The discount offer may be a combination of a discount offered by the online retailer and a discount offered by a supplier of a product or service offered by the online retailer associated with the retail server 720. In one embodiment, the discount offer 740 is transmitted to the client device 710. The discount offer 740 may be a graphic including a total percentage discount offered or include various discount percentages for different products or services offered by the online retailer.

At step 744 the user of the client device 710 purchases a product eligible for the discount offer. A purchase request 746 is sent from the client device 710 to the retail server 720. The retail server 720 may then process the purchase request by collecting payment information, shipping information, and other information that is needed to complete the transaction. These communications are not shown in FIG. 7. Upon completing the purchase, the retail server 720 sends a discount confirmation 748 to the discount server 730. The discount server 730 will keep track of various purchases made by users. The purchase confirmation 748 may include a rebate amount due to the user of the client device 710.

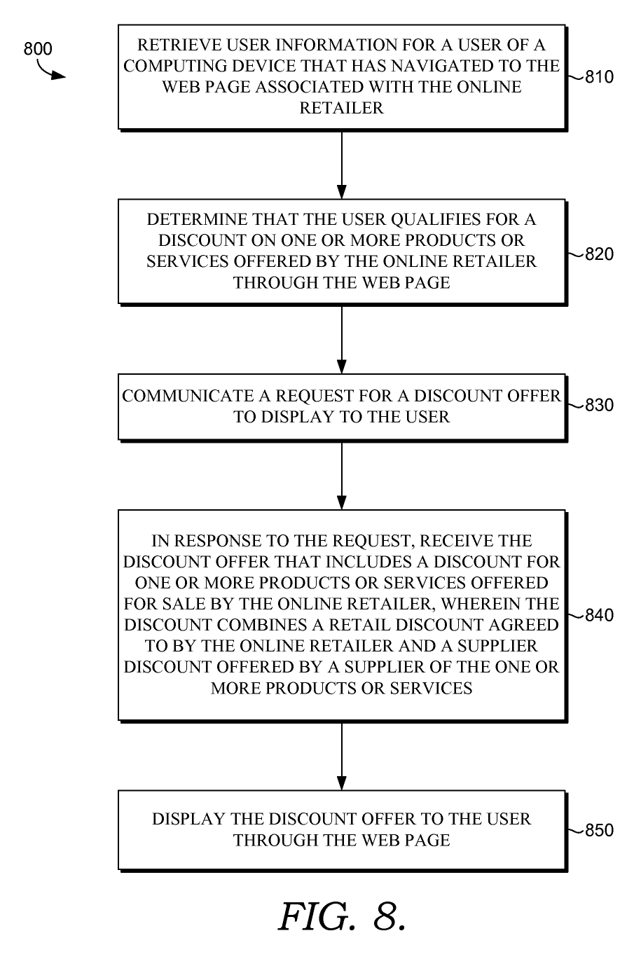

Turning now to FIG. 8, a method of presenting a targeted-discount offer to a user viewing a web page associated with an online retailer is shown according to embodiments of the present invention. An online retailer is a merchant that sells goods and/or services through a web page. The targeted-discount offer is presented through the web page and offers the user a percentage discount on products or services provided by the online retailer. At step 810, the user information for a user of a computing device that has navigated to the web page associated with the online retailer is retrieved. In one embodiment, the user information is retrieved from a cookie that is placed on the user's computing device when the user joins a discount program from which the discount offer is provided. The user information may include a unique user ID. In one embodiment, the user information is retrieved by a widget associated with the web page that executed by the user's browser. At step 820, it is determined that the user qualifies for a discount on one or more products or services offered by the online retailer through the web page. The widget may determine that the user qualifies for a discount by determining that the user navigated to the web page through a portal site provided by an entity managing the discount program. Additionally, the cookie described previously may indicate the user's membership in the discount program. In one embodiment, the user must have both the cookie and navigate to the website through a portal affiliated with the discount program to qualify for the discount program.

At step 830, a request for a discount offer is communicated to a discount server that provides discount offers targeted to the user. The request may be communicated by a browser displaying the online retailer's web page. In another embodiment, the request is generated by the server hosting the online retailer's web page. The request may include a unique user identification for the user that navigated to the web page, a unique merchant identification that identifies the online retailer, product information for products displayed on the web page, and a URL for the particular web page within the online retailer's website to which the user navigated. The URL may be used by the discount server to analyze the web page to which the user navigated to tailor a discount offer to a specific product or service provided by the online retailer on the particular web page associated with the URL.

At step 840, in response to the request for a discount offer, the discount offer is received from the discount server. The discount offer may include a percentage discount for one or more products or services offered for sale by the online retailer. The percentage discount within the discount offer may be a combination of a discount offered by the online retailer and a discount offered by a supplier of the one or more products or services offered by the online retailer. For example, the online retailer may offer a discount of 2.5% on all products and services sold through its web page. In addition, a supplier of a TV may offer a 10% discount for a class of televisions or a particular model of televisions sold by the online retailer. The discount offer may then offer a 12.5% discount for TVs made by the supplier or even a particular model of TV made by the supplier. Other types of discount offers are also possible. In one embodiment, the discount offer is based on a previous purchase made by the user at a separate online retailer. For example, the user may have purchased a DVD player at an electronics online retailer previously. A targeted-discount offer for DVD's published by the same supplier of the previously purchased DVD player may be made through a second online retailer that sells books and media. The discount offer could also be in the form of a two for one offer or a dollar amount off the purchase price. Other types of discount offers may also be possible.

At step 850, the discount offer is displayed to the user through the web page. The discount offer may include a discount to be offered on one or more products or services. If the user purchases a good or service that qualifies for a percentage discount in the discount offer, then the web server may calculate a rebate due to the user by multiplying the price of the product purchased by the percentage of the discount offered. The calculated rebate amount may be transmitted with a purchase confirmation to the discount server that is coordinating the discount program. In another embodiment, the discount offer may be a fixed dollar amount off of a group of goods or services. The fixed dollar amount may then be transmitted with the purchase confirmation to the discount server.

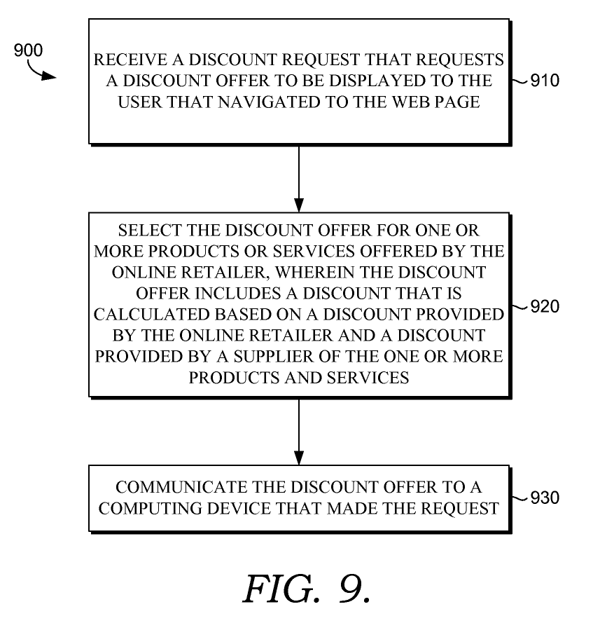

Turning now to FIG. 9, a method of presenting a targeted-discount offer to a user viewing a web page associated with an online retailer is shown in accordance with an embodiment of the present invention. At step 910, a discount request is received that identifies a user and an online retailer. The discount request requests a discount offer that is to be displayed to the user that navigated to the web page associated with the online retailer. The discount request includes a unique user identification that identifies the user and a unique retailer identification that identifies the online retailer. The discount request may also include product information identifying products offered for sale on the online retailer's web page.

At step 920, the discount offer is selected for one or more products or services offered by the online retailer. The discount offer includes a discount that is calculated based on a discount provided by the online retailer and a discount provided by a supplier of the one or more products and services. The various discounts offered by online retailers and suppliers of products and services may be stored in a data store by a discount server that coordinates a discount program. In one embodiment, the discount server selects the discount offer to be presented to a particular user on a particular online retailer's website. At step 930, the discount offer is communicated to a computing device hosting the web page that requested the discount server.

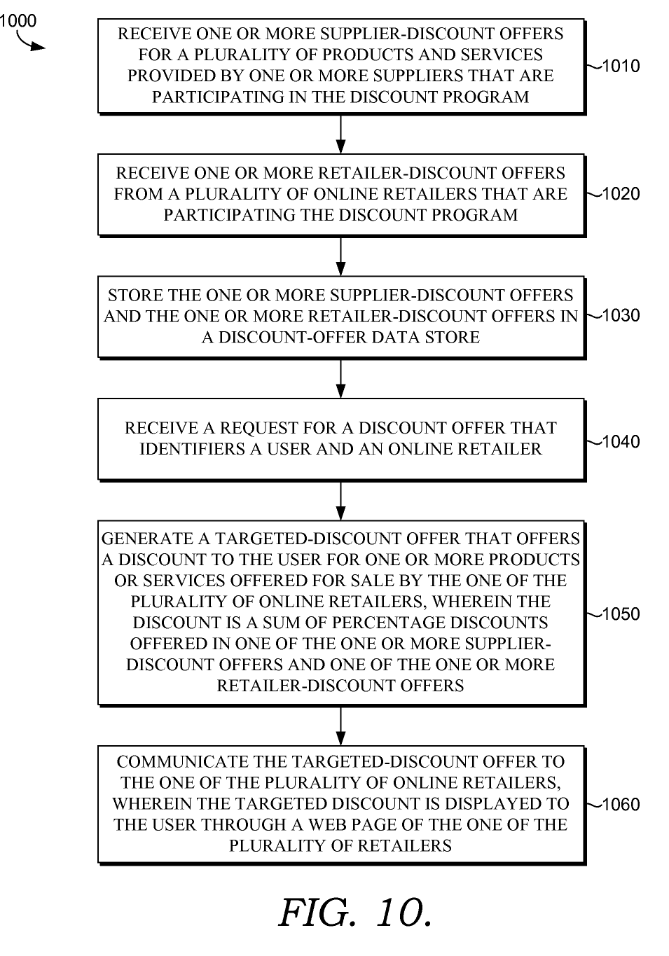

Turning now to FIG. 10, a method for presenting online discount offers to members of a discount program through retailer web pages associated with retailers that are also participating in the discount program is shown in accordance with an embodiment of the present invention. At step 1010, one or more supplier-discount offers for a plurality of products and services provided by the one or more suppliers that are participating in the discount program are received. As explained previously the supplier-discount offers may come in a wide variety of forms. For example the supplier-discount offer may offer a percentage discount on a particular product, a class of products or any product or service supplied by the supplier. In general, the supplier-discount offers will apply to products and services supplied by the supplier. In one embodiment, the supplier-discount offers are based on purchasing two or more products or services. In one embodiment, the combination discount allows two or more goods or services to be purchased through different online retailers at different times. In another embodiment, a supplier-discount offer may be for a combination of two or more products or services one of which the user may have purchased from a different supplier. For example, a supplier may be willing to offer a discount on hotels to a user who is known to have purchased airline tickets from a separate online retailer and separate supplier.

At step 1020, one or more retailer-discount offers are received from a plurality of online retailers that are participating in the discount program. The one or more retailer-discount offers may be for a particular type of product, a particular product or service, a particular class of product or service, or generally apply to all products and services offered by the online retailer.

At step 1030, the one or more supplier-discount offers and the one or more retailer-discount offers are stored in a discount-offered data store that includes one or more computer-storage media.

At step 1040, a request for a discount offer is received from one of the plurality of online retailers participating in the discount program. The request includes a unique identifier describing the user and a unique identifier describing the one or more of the plurality of online retailers. At step 1050, a targeted-discount offer that offers a discount to the user for one or more products or services offered for sale by the one of the plurality of online retailers is generated. The discount is a combination of the discounts offered by the one or more supplier-discount offers and the one or more retailer-discount offers. At step 1060, the targeted-discount offer is communicated to the one of the plurality of online retailers. The targeted-discount offer is displayed to the user through a web page of the one or more plurality of retailers.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-readable media having computer-executable instructions embodied thereon for performing a method of presenting a targeted-discount offer to a user viewing a web page associated with an online retailer, the method comprising:
retrieving user information for the user of a computing device that has navigated to the web page associated with the online retailer, wherein the online retailer is an entity offering products or services for sale through the web page, and wherein the user information includes a unique user identification that identifies the user;
determining that the user qualifies for a discount on one or more products or services offered by the online retailer through the web page;
communicating a request for a discount offer to display to the user, wherein the request includes the unique user identification and a unique merchant identification that identifies the online retailer;
in response to the request, receiving the discount offer that includes a discount for one or more products or services offered for sale by the online retailer, wherein the discount combines a retail discount agreed to by the online retailer and a supplier discount offered by a supplier of the one or more products or services; and
displaying the discount offer to the user through the web page.

2. The media of claim 1, wherein the user information is retrieved from a cookie on the computing device being used by the user to access the web page, and wherein the cookie is placed on the computing device when the user joins a discount program.

3. The media of claim 1, wherein the method further includes:
determining that the user purchased at least one of the one or more products or services to which the discount offer applies;
communicating a message to a discount server that includes a description of the at least one of the one or more products or services, the unique user identification, and the unique merchant identification.

4. The media of claim 3, wherein the method further comprises calculating a rebate due to the user equal to a product of multiplying a percentage discount by a price of the at least one of the one or more products or services purchased by the user.

5. The media of claim 1, wherein the discount for the one or more products or services is based on the user previously purchasing a different product or service from a different online retailer.

6. The media of claim 1, wherein the discount offer includes the discount for purchasing the one or more products or services and a second discount for purchasing two or more of the one or more products or services.

7. The media of claim 1, wherein the user qualifies for the discount on the one or more products or the services because the user navigated to the web page or a web site of which the web page is a part from a third party web site associated with a third part entity that generates the discount offer.

8. One or more computer-readable media having computer-executable instructions embodied thereon for performing a method of selecting a targeted-discount offer for presentation to a user viewing a web page associated with an online retailer, the method comprising:
receiving a discount request from a computing device for a discount offer to display to the user that navigated to the web page associated with the online retailer, wherein the discount request includes a unique user identification that identifies the user and a unique retailer identification that identifies the online retailer;
in response to the discount request, selecting the discount offer for one or more products or services offered by the online retailer, wherein the discount offer includes a total discount that is calculated based on a discount provided by the online retailer and a discount provided by a supplier of the one or more products and services; and
communicating the discount offer to the computing device.

9. The media of claim 8, wherein the discount offer is a combination offer for at least two products, wherein the user gets an additional discount for purchasing two or more of the at least two products.

10. The media of claim 9, wherein one of the at least two products was previously purchased from a different online retailer through a different web page.

11. The media of claim 8, wherein the method further comprises:
storing information associated with the discount request in a user information data store that includes information associated with a plurality of discount requests associated with a plurality of users, wherein each of the plurality of discount requests is stored in association with the unique user identification within said each of the plurality of discount requests.

12. The media of claim 8, wherein the method further includes:
receiving supplier-discount offers for a plurality of products or services supplied by a plurality of suppliers;
receiving retailer-discount offers from a plurality of retailers;
storing the supplier-discount offers and the retailer-discount offers in a data store.

13. The media of claim 8, wherein the method further includes receiving a notification from the web page indicating that the user purchased at least one of the one or more products or services and crediting a percentage of a purchase price for the one or more products or services to an account associated with the user.

14. A method for presenting online discount offers to members of a discount program through retailer web pages associated with retailers that are participating in the discount program, the method comprises:
receiving one or more supplier-discount offers for a plurality of products and services provided by one or more suppliers that are participating in the discount program;
receiving one or more retailer-discount offers from a plurality of online retailers that are participating in the discount program;
storing the one or more supplier-discount offers and the one or more retailer-discount offers in a discount-offer data store, comprising one or more computer-storage media;
receiving a request for a discount offer from a computing device, wherein the request includes a unique identifier describing a user and a unique identifier describing the one of the plurality of online retailers;
generating a targeted-discount offer that offers a discount to the user for one or more products or services offered for sale by the one of the plurality of online retailers, wherein the discount is a combination of discounts offered in one of the one or more supplier-discount offers and one of the one or more retailer-discount offers; and
communicating the targeted-discount offer to the computing device, wherein the targeted-discount offer is displayed to the user through a web page of the one of the plurality of retailers.

15. The method of claim 14, wherein the method further includes:
providing a user interface through a membership web page that allows users to subscribe to the discount program by submitting membership information to a discount server that coordinates the discount program;
receiving membership information for the user; and
in response to receiving the membership information, placing a cookie on a user's computing device through which the user submitted the membership information, wherein the cookie indicates the user is a member of the discount program, and wherein the cookie includes the unique identifier for the user.

16. The method of claim 14, wherein the method further includes:
receiving a purchase indication that at least one of the one or more products or services displayed in the targeted-discount offer was purchased by the user, wherein the purchase indication includes a unique user identification, a description of the at least one of the one or more products or services, and a price paid for the at least one of the one or more products or services;
generating a shopping history for a plurality of users by using the unique identifier describing the user and a url in each request for a discount received along with purchase indications received for the plurality of users.

17. The method of claim 14, wherein an individual-retailer discount specifies a percentage discount for all products or services offered by an individual online retailer that submitted the individual-retailer discount.

18. The method of claim 14, wherein an individual-retailer discount specifies a discount for specific products or services offered by an individual online retailer that submitted the individual-retailer discount.

19. The method of claim 14, wherein the user qualifies for a discount on the one or more products or the services because the user navigated to the web page or a web site of which the web page is a part from a third party web site associated with a third part entity that generates the discount offer.

20. The method of claim 14, wherein the targeted-discount offer is based on a previous purchase made by the user through a second one of the plurality of online retailers other than the one of the one of the plurality of online retailers.
